(19) United States
(12) Patent Application Publication
(10) Pub. No.: US 2017/0328464 A1
(43) Pub. Date: Nov. 16, 2017

(54) SHIFT DEVICE

(71) Applicant: KABUSHIKI KAISHA TOKAI-RIKA-DENKI-SEISAKUSHO, Aichi (JP)

(72) Inventor: Norihiro YAMAMURA, Aichi (JP)

(21) Appl. No.: 15/528,667

(22) PCT Filed: Nov. 12, 2015
(86) PCT No.: PCT/JP2015/081880

§ 371 Date: May 22, 2017

(30) Foreign Application Priority Data
Nov. 25, 2014 (JP) 2014-238224

(51) Int. Cl. F16H 59/02

(52) U.S. Cl. CPC F16H 59/0278

(57) ABSTRACT

In a lever of a shift lever device, a button on the lever is press-operated such that the button swings to slide a link and slide a detent rod along an axial direction. When the button is press-operated, the link slides along the axial direction of the detent rod and presses the detent rod along the axial direction. Accordingly, the sliding resistance of the detent rod can be reduced.

### TECHNICAL FIELD

The present invention relates to a shift device in which a shift position is changed due to moving a shift body.

### BACKGROUND ART

In the shift lever described in Japanese Patent Application Laid-Open (JP-A) No. 2005-319840, a button and a link member are provided at a knob, and a detent rod is provided inside a lever body. By operating the button such that the link member is swung, the link member presses the detent rod and slides the detent rod along an axial direction.

In such a shift lever, it would be preferable to be able to reduce the sliding resistance of the detent rod.

### SUMMARY OF INVENTION

### Technical Problem

In consideration of the above circumstances, an object of the present invention is to obtain a shift device capable of reducing the sliding resistance of a sliding body.

### Solution to Problem

A shift device of a first aspect of the present invention includes a shift body that is moved to change a shift position, a sliding body that is provided at the shift body so as to be slidable along a predetermined direction, and a pressing body that is provided at the shift body, and that presses and slides the sliding body along the predetermined direction through operation by a vehicle occupant on the shift body.

A shift device of a second aspect of the present invention includes a shift body that is moved to change a shift position, a sliding body that is provided at the shift body so as to be slidable along a predetermined direction, an operation body that is provided at the shift body so as to be operable by a vehicle occupant, and a pressing body that is provided at the shift body, and that presses the sliding body and slides the sliding body along the predetermined direction due to the operation body being operated and the pressing body being slid.

A shift device of a third aspect of the present invention is the shift device of the first aspect or the second aspect of the present invention, further including an inclined face that is provided at the pressing body, and that is inclined with respect to the predetermined direction such that, due to pressing of the inclined face, the pressing body presses the sliding body and slides the sliding body along the predetermined direction.

A shift device of a fourth aspect of the present invention is the shift device of any one of the first aspect to the third aspect of the present invention, wherein the pressing body is able to make contact with the sliding body only in the predetermined direction.

### Advantageous Effects of Invention

In the shift device of the first aspect of the present invention, the shift body is moved to change the shift position. Further, the sliding body is provided at the shift body, and the sliding body is slidable along the predetermined direction. Additionally, the pressing body is provided at the shift body. The pressing body presses and slides the sliding body along the predetermined direction through operation by a vehicle occupant on the shift body.

The pressing body presses the sliding body along the predetermined direction, this being a sliding direction. This enables the sliding resistance of the sliding body to be reduced.

In the shift device of the second aspect of the present invention, the shift body is moved to change the shift position. Further, the sliding body is provided at the shift body, and the sliding body is slidable along the predetermined direction. Additionally, the operation body and the pressing body are provided at the shift body. The pressing body presses the sliding body and slides the sliding body along the predetermined direction due to operation by the vehicle occupant on the operation body.

The pressing body is slid to press the sliding body and slide the sliding body along the predetermined direction. This enables the pressing body to be suppressed from pressing the sliding body in a direction perpendicular to the predetermined direction, this being the sliding direction, and enables the sliding resistance of the sliding body to be reduced.

In the shift device of the third aspect of the present invention, the inclined face provided at the pressing body is inclined with respect to the predetermined direction such that, due to pressing of the inclined face, the pressing body presses the sliding body and slides the sliding body along the predetermined direction. This enables the load on the pressing body for causing the sliding body to slide along the predetermined direction to be easily adjusted.

In the shift device of the fourth aspect of the present invention, the pressing body is able to make contact with the sliding body only in the predetermined direction. This enables the pressing body to be effectively suppressed from pressing the sliding body in a direction perpendicular to the predetermined direction, this being the sliding direction, and enables the sliding resistance of the sliding body to be effectively reduced.

### BRIEF DESCRIPTION OF DRAWINGS

FIG. 1 is a perspective view illustrating a lever in a shift lever device according to an exemplary embodiment of the present invention, as viewed obliquely from the rear right.

FIG. 2 is a cross-section illustrating the lever in the shift lever device according to the exemplary embodiment of the present invention, as viewed from the right.

FIG. 3 is a cross-section illustrating the lever in the shift lever device according to the exemplary embodiment of the present invention during button operation, as viewed from the right.

### DESCRIPTION OF EMBODIMENTS

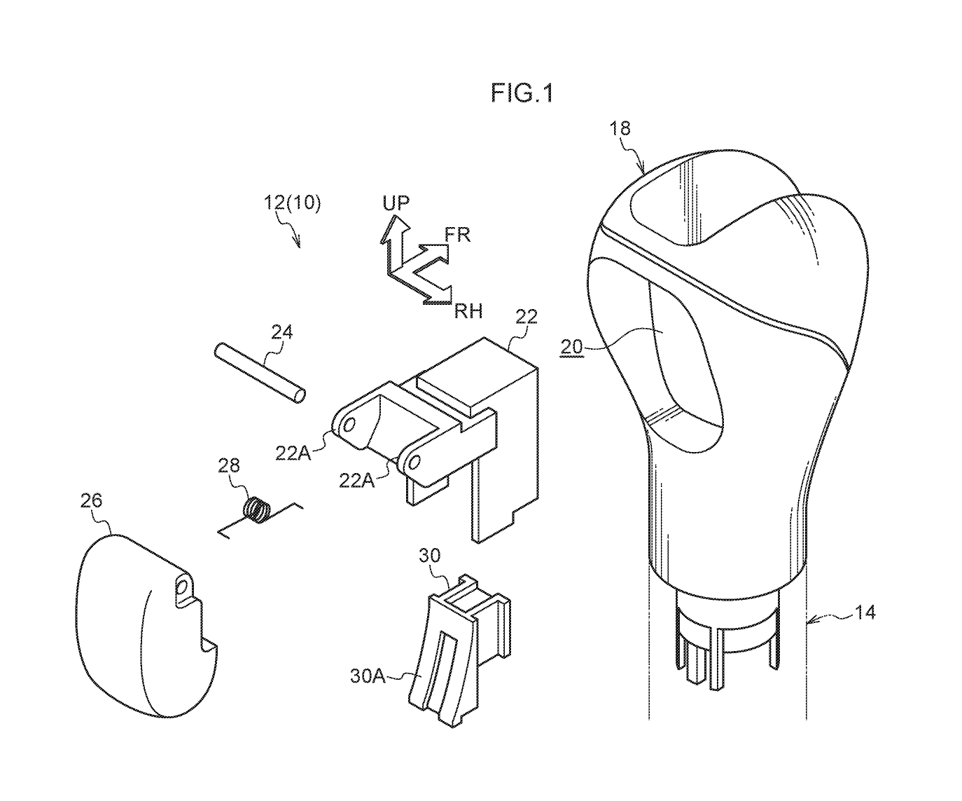

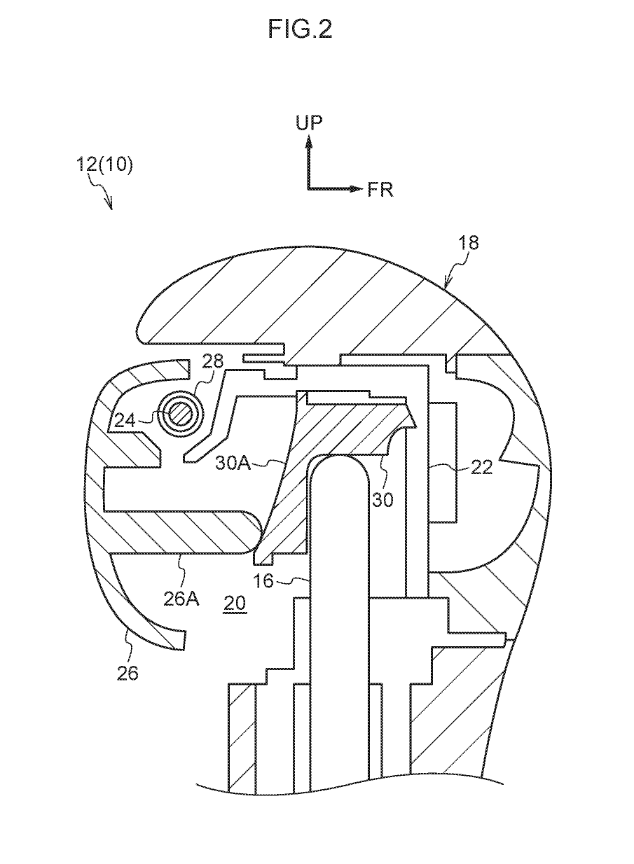

FIG. 1 is a perspective view illustrating relevant elements of a shift lever device 10 serving as a shift device according to an exemplary embodiment of the present invention, as viewed obliquely from the rear right. FIG. 2 is a cross-section illustrating relevant elements of the shift lever device 10, as viewed from the right. Note that in the drawings, the arrow FR indicates the front of the shift lever device 10, the arrow RH indicates the right of the shift lever device 10, and the arrow UP indicates the upper side of the shift lever device 10.

The shift lever device 10 according to the present exemplary embodiment is what is called a straight shift device. The shift lever device 10 is floor-mounted and installed to a floor section of a vehicle cabin at the vehicle width direction inside of a driver seat (not illustrated in the drawings) of a vehicle (automobile). The front, left, and upper side of the shift lever device 10 respectively face the front, left, and upper side of the vehicle.

The shift lever device 10 is provided with a housing (not illustrated in the drawings), this being at a vehicle body. The housing is fixed to the floor section of the vehicle cabin.

As illustrated in FIG. 1 and FIG. 2, a lower end (base end) of a substantially rod shaped lever 12, serving as a shift body, is supported within the housing. The lever 12 extends out from the housing toward the upper side, and the lever 12 can be swung (moved) about its lower end along a front-rear direction (along one direction). A shift position can be changed due to swinging the lever 12, and, for example, the lever 12 is capable of being placed in a P position (park position), an R position (reverse position), an N position (neutral position), and a D position (drive position) on progression from a front side toward a rear side.

A circular tube shaped lever body 14, serving as a body section, is provided at the lever 12. The lever body 14 is disposed along the length direction of the lever 12, except for at an upper end portion (leading end portion) of the lever 12.

A substantially circular column shaped detent rod 16, serving as a sliding body configuring a restriction means, is coaxially housed inside the lever body 14. The detent rod 16 is supported so as to be slidable along an axial direction (a predetermined direction) of the lever body 14. The detent rod 16 extends out toward the upper side of the lever body 14, and an upper end portion of the detent rod 16 has a hemispherical shape.

A cylindrically shaped detent pin (not illustrated in the drawings), serving as an engagement member configuring the restriction means, is fixed to the detent rod 16. The detent pin extends out from the detent rod 16 in the left-right direction. The detent pin extends out from the lever body 14 in the left-right direction. The lever body 14 allows the detent pin to slide as a unit together with the detent rod 16.

A restriction spring (not illustrated in the drawings), serving as a slide biasing means configuring the restriction means, is provided inside the lever body 14 at a lower side of the detent rod 16. The restriction spring biases the detent rod 16 and the detent pin toward the upper side.

A detent plate (not illustrated in the drawings), serving as a catching member configuring the restriction means, is fixed inside the housing at the left-right direction outer sides of the lever body 14. A detent groove of a predetermined shape (not illustrated in the drawings) is formed in the detent plate. Biasing force from the restriction spring causes the detent pin to engage the detent groove. When swinging of the detent pin, as a unit together with the lever body 14, is caught by the detent groove (for example, when the shift position of the lever 12 has been changed from the P position to the R position), swinging of the lever 12 is restricted, and changing of the shift position of the lever 12 is restricted.

A substantially spherically shaped hollow knob 18, serving as a grip section, is provided at the upper end portion of the lever 12. The knob 18 is fixed to an upper end portion of the lever body 14. The knob 18 is configured to be grippable by an occupant of the vehicle, and an occupant is able to swing-operate the lever 12 due to gripping the knob 18.

A substantially cuboid shaped housing space 20 is formed inside the knob 18. The housing space 20 is open to the lower side and inserted with the detent rod 16, and the housing space 20 is open to the rear side.

A substantially cuboid box shaped holder 22, serving as a guide member, is fixed in the housing space 20. The inside of the holder 22 is open to the lower side and inserted with the detent rod 16, and the inside of the holder 22 is open to the rear side. A pair of substantially triangular plate shaped support plates 22A are integrally provided at an upper portion of the holder 22. The pair of support plates 22A respectively project out toward the rear side and oppose each other in the left-right direction.

A circular column shaped pin 24, serving as a support member, extends between the pair of support plates 22A. The axial direction of the pin 24 is disposed parallel to the left-right direction.

An upper end portion of a substantially cuboid box shaped button 26, serving as an operation body, is supported by the pin 24. The button 26 is capable of swinging about the center axis of the pin 24 in the front-rear direction and has an opened front face. The button 26 is disposed at a portion of the housing space 20 exposed to the rear side. The button 26 is exposed to the outside of the knob 18 such that the occupant gripping the knob 18 is able to press-operate the button 26 toward the front side. A substantially rectangular plate shaped operation plate 26A, serving as an operation portion, is integrally provided at a rear wall inner face of the button 26. The operation plate 26A is disposed perpendicular to the axial direction of the detent rod 16. The operation plate 26A extends out from the button 26 toward the front side, and a front end portion of the operation plate 26A has a semicircular cross-section.

The pin 24 penetrates the inside of an operation spring 28, serving as an operation biasing means, between the pair of support plates 22A. The operation spring 28 extends between the holder 22 and the button 26 and biases the button 26 toward the rear side. The biasing force of the operation spring 28 is smaller than the biasing force of the restriction spring.

A substantially cuboid box shaped link 30, serving as a pressing body, is provided inside the holder 22. The holder 22 restricts movement of the link 30 toward the radial direction sides of the detent rod 16 (in the front-rear direction and the left-right direction), and the holder 22 is configured capable of guiding sliding of the link 30 along the axial direction (up-down direction) of the detent rod 16. A front face and lower face of the link 30 are open.

An upper end of the detent rod 16 makes contact with an upper wall of the link 30 from the lower side, and an upper wall of the holder 22 abuts the link 30. The detent rod 16 only makes contact with the link 30 at the upper wall of the link 30. The detent rod 16 only makes contact with the link 30 in the axial direction of the detent rod 16, and does not make contact with the link 30 at the radial direction sides of the detent rod 16.

An inclined face 30A is formed to the rear face of the link 30. The inclined face 30A is inclined in a direction towards the front side on progression towards the upper side, is inclined with respect to the axial direction of the detent rod 16, and is curved in a concave shape. Biasing force from the operation spring 28A causes the front end portion of the operation plate 26A of the button 26 to make contact with a lower end of the inclined face 30A. The inclined face 30A restricts swinging of the button 26 toward the rear side by the biasing force of the operation spring 28.

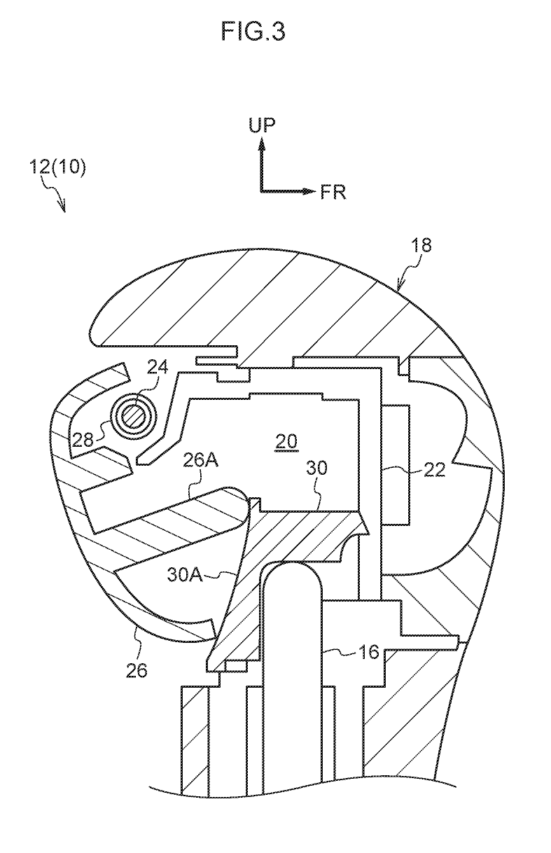

As illustrated in FIG. 3, when the button 26 is press-operated toward the front side such that the button 26 swings toward the front side against the biasing force of the operation spring 28, the front end portion of the operation plate 26A presses against the inclined face 30A toward the upper side and glides toward the upper side, and the link 30 slides toward the lower side against the biasing force of the restriction spring. The upper wall of the link 30 thereby presses the detent rod 16 toward the lower side, and the detent rod 16 and the detent pin slide toward the lower side against the biasing force of the restriction spring. Accordingly, engagement of the detent pin in the detent groove of the detent plate is released, and since the detent groove does not catch the swinging of the detent pin, restriction on the swinging of the lever 12 is released, allowing the shift position of the lever 12 to be changed.

When the button 26 is swung, the contact angle between the front end portion of the operation plate 26A and the inclined face 30A (the angle between a swing tangential line direction of the button 26 (the direction of pressing the inclined face 30A) and a tangential line of the inclined face 30A, in a contact position between the front end portion of the operation plate 26A and the inclined face 30A) is kept constant.

Next, explanation follows regarding operation of the present exemplary embodiment.

In the lever 12 of the shift lever device 10 configured as described above, when the button 26 of the knob 18 is press-operated toward the front side such that the button 26 swings toward the front side, the front end portion of the operation plate 26A of the button 26 presses against the inclined face 30A of the link 30 toward the upper side and glides toward the upper side, and the link 30 slides toward the lower side. The upper wall of the link 30 thereby presses the detent rod 16 toward the lower side, and the detent rod 16 slides toward the lower side (along the axial direction).

When the button 26 is press-operated, the link 30 slides along the axial direction of the detent rod 16, and the link 30 presses the detent rod 16 along the axial direction, this being the sliding direction. This enables the link 30 to be suppressed from pressing the detent rod 16 toward the radial direction sides, these being in directions perpendicular to the sliding direction; enables the sliding resistance of the detent rod 16 to be reduced; enables the load for causing the link 30 and the detent rod 16 to slide to be reduced; and enables the load to press-operate the button 26 to be reduced.

Additionally, when the button 26 is press-operated, the detent rod 16 makes contact with the link 30 only at the upper wall of the link 30, and the detent rod 16 makes contact with the link 30 only in the axial direction of the detent rod 16. This enables the link 30 to be effectively suppressed from pressing the detent rod 16 toward the radial direction sides, these being in directions perpendicular to the sliding direction; enables the sliding resistance of the detent rod 16 to be effectively reduced; and enables the load to press-operate the button 26 to be effectively reduced.

Further, the link 30 is only slidably supported by the holder 22. A pair of support shafts are not needed, in contrast to cases in which the link 30 is supported by respective support shafts of the holder 22 and the button 26 so as to be capable of swinging relative to the support shafts. This enables the load to press-operate the button 26 to be even more effectively reduced, as the pair of support shafts do not generate gliding resistance when the button 26 is press-operated. Further, the number of components in the lever 12 can be reduced, enabling the ease of assembly of the lever 12 to be improved and enabling costs to be reduced.

Further, the inclined face 30A of the link 30 is inclined with respect to the axial direction of the detent rod 16, and the inclination angle of the inclined face 30A can be easily adjusted. This enables the contact angle between the front end portion of the operation plate 26A and the inclined face 30A to be easily adjusted, enables the load for the front end portion of the operation plate 26A to cause the inclined face 30A to slide to be easily adjusted, and enables the load to press-operate the button 26 to be easily adjusted. Further, the relationship between the swing stroke of the front end portion of the operation plate 26A and the sliding stroke of the inclined face 30A can be easily adjusted; and the relationship between the press-operation stroke of the button 26, and the sliding stroke of the link 30 and the detent rod 16 (including the detent pin) can be easily adjusted.

Additionally, when the button 26 is press-operated and the button 26 swings, the contact angle between the front end portion of the operation plate 26A and the inclined face 30A can be kept constant. This enables the load for the front end portion of the operation plate 26A to cause the inclined face 30A to slide to be made steady, and enables the load to press-operate the button 26 to be made steady.

Further, the button 26 is swung toward the front side to slide the inclined face 30A toward the lower side. This enables the inclination angle of the inclined face 30A with respect to the front-rear direction to be increased, enables the front-rear direction dimension of the inclined face 30A to be decreased, and enables the front-rear direction dimension of the link 30, and by extension the knob 18, to be decreased compared to cases in which the inclined face 30A slides toward the lower side due to the button 26 sliding toward the front side.

Note that in the present exemplary embodiment, the link 30 is slidable along the axial direction of the detent rod 16. However, the link 30 may be configured to be slidable along a direction intersecting the axial direction of the detent rod 16.

Further, in the present exemplary embodiment, the shift lever device 10 is floor-mounted and installed to a floor section of a vehicle cabin. However, the shift lever device 10 may be installed to a column covering or an instrument panel in the vehicle cabin.

The entire content of the disclosure of Japanese Patent Application No. 2014-238224 filed Nov. 25, 2014 is incorporated by reference in the present specification.

### EXPLANATION OF THE REFERENCE NUMERALS

10 shift lever device (shift device)
12 lever (shift body)
16 detent rod (sliding body)
26 button (operation body)
30 link (pressing body)
30A inclined face

1. A shift device comprising:
a shift body that is moved to change a shift position;
a sliding body that is provided at the shift body so as to be slidable along a predetermined direction; and
a pressing body that is provided at the shift body, and that is provided with an inclined face inclined with respect to the predetermined direction such that, due to the inclined face being pressed through operation by a vehicle occupant on the shift body, the pressing body presses and slides the sliding body along the predetermined direction.

2. A shift device comprising:
a shift body that is moved to change a shift position;
a sliding body that is provided at the shift body so as to be slidable along a predetermined direction;
an operation body that is provided at the shift body so as to be operable by a vehicle occupant; and
a pressing body that is provided at the shift body, that presses the sliding body and slides the sliding body along the predetermined direction due to the operation body being operated and the pressing body being slid, and that maintains a contact angle with the operation body.

3. (canceled)

4. The shift device of claim 2, wherein the operation body is operated and swung.

5. The shift device of claim 2, wherein, on the operation body, a contact face that contacts the pressing body is curved.

6. The shift device of claim 2, further comprising:
an inclined face that is provided at the pressing body, and that is inclined with respect to the predetermined direction such that, due to pressing of the inclined face, the pressing body presses the sliding body and slides the sliding body along the predetermined direction.

7. The shift device of claim 1, wherein the inclined face is curved.

8. The shift device of claim 1, wherein the pressing body is able to make contact with the sliding body only in the predetermined direction.
